(19) United States
(12) Patent Application Publication
(10) Pub. No.: US 2011/0320978 A1
(43) Pub. Date: Dec. 29, 2011

(54) METHOD AND APPARATUS FOR TOUCHSCREEN GESTURE RECOGNITION OVERLAY

(76) Inventors: Samuel J. Horodezky, San Diego, CA (US); Kam-Cheong Anthony Tsoi, San Diego, CA (US); Kathleen M. Bruce, San Diego, CA (US)

(21) Appl. No.: 12/825,992

(22) Filed: Jun. 29, 2010

(51) Int. Cl. G06F 3/048; G06F 3/041; G06F 3/033

(52) U.S. Cl. 715/823; 715/858; 345/173; 715/863; 715/810

(57) ABSTRACT

Methods and devices provide a user interface featuring a gesture recognition overlay suitable for the small display of a mobile device equipped with a touchscreen user input/display. Such a gesture recognition overlay functionality may enable users to enter alphanumeric text and edit text by performing simple gestures on an overlay presented above other images on the touchscreen display. By providing a larger area for accepting user input touch gestures as well as presenting menus, the various embodiments facilitate text entry and editing operations on the relatively small area of most mobile device touchscreen displays. A variety of functions may be correlated to user inputs within the gesture recognition overlay, and various operating modes may be included in the functionality, such as a text selection mode and a toolbar menu mode.

### FIELD OF THE INVENTION

This application relates generally to computing device user interfaces, and more particularly to user interfaces suitable for touchscreen-equipped mobile devices.

### BACKGROUND

Mobile computing devices (e.g. cell phones, PDAs, laptops, gaming devices) increasingly rely on touchscreen user interfaces over traditional button-based user interfaces. Accordingly, many touchscreen-equipped mobile devices rely primarily on virtual keyboards for alphanumeric text entry. In addition to providing virtual buttons and virtual keyboards, touchscreen devices may provide for user input gestures. For example, in some mobile devices a user may drag a finger or stylus down the touchscreen to scroll a list.

### SUMMARY

The various embodiments provide a method of implementing a user interface function on a computing device equipped with a touchscreen display, which includes displaying a translucent gesture recognition overlay area on a portion of the touchscreen display, detecting a first touch event on the touchscreen within the gesture recognition overlay, determining an intended cursor movement within a displayed text string based on the detected first touch event, determining an alphanumeric character, punctuation mark, special character or string (e.g., “www” or “.com”) adjacent to a current position of a cursor within the displayed text string after the determined intended cursor movement, displaying on the touchscreen an enlarged portion of the alphanumeric or other character, and updating the cursor position in the displayed text string. In a further embodiment displaying a translucent gesture recognition overlay area on a portion of the touchscreen display is accomplished in response to detecting a user input corresponding to activation of a gesture recognition overlay functionality. In a further embodiment, determining an intended cursor movement within a displayed text string based on the detected touch event includes determining from the first touch event whether a user has touched the gesture recognition overlay with a finger or stylus near an edge, and determining from motion of the first touch event whether the user has dragged the finger or stylus towards the opposite edge of the gesture recognition overlay along a centerline. In a further embodiment, displaying on the touchscreen an enlarged portion of the alphanumeric or other character includes displaying an enlarged portion of the alphanumeric character within the gesture recognition overlay, and periodically updating the display of the enlarged portion based on movement of the first touch event across the gesture recognition overlay. In another embodiment the method further includes recognizing a character sketched in the gesture recognition overlay and adding the recognized character to the displayed text string at the updated cursor position. In another embodiment the method further includes detecting a user input corresponding to activation of a text selection mode, and highlighting the alphanumeric or other character when the text selection mode is activated. In another embodiment the method further includes detecting a user input corresponding to activation of a text selection mode, and highlighting a word in a direction of movement of the first touch event when the text selection mode is activated. In another embodiment the method further includes determining a speed of movement of the first user input, wherein determining an intended cursor movement within a displayed text string based on the detected first touch event includes determining that a single character movement of the cursor is intended when the speed of movement of the first user input is slow, and determining that a multi-character movement of the cursor is intended when the speed of the movement of the first user input is fast. In another embodiment the method further includes displaying a menu of functions including one or more menu icons within the gesture recognition overlay in response to detecting a user input corresponding to activation of a toolbar functionality, detecting a user touch on one or more menu icons, and implementing a function corresponding to the touch one or more menu icons.

In further embodiments, a computing device includes a touchscreen display coupled to a processor which is configured with processor-executable instructions to perform operations including displaying a translucent gesture recognition overlay area on a portion of the touchscreen display, detecting a first touch event on the touchscreen within the gesture recognition overlay, determining an intended cursor movement within a displayed text string based on the detected first touch event, determining an alphanumeric or other character adjacent to a current position of a cursor within the displayed text string after the determined intended cursor movement, displaying on the touchscreen an enlarged portion of the alphanumeric or other character, and updating the cursor position in the displayed text string. In a further embodiment the processor may be configured such that displaying a translucent gesture recognition overlay area on a portion of the touchscreen display is accomplished in response to detecting a user input corresponding to activation of a gesture recognition overlay functionality. In a further embodiment, the processor may be configured such that determining an intended cursor movement within a displayed text string based on the detected touch event includes determining from the first touch event whether a user has touched the gesture recognition overlay with a finger or stylus near an edge, and determining from motion of the first touch event whether the user has dragged the finger or stylus towards the opposite edge of the gesture recognition overlay along a centerline. In a further embodiment, the processor may be configured to perform further operations including displaying, on the touchscreen, an enlarged portion of the alphanumeric or other character includes displaying an enlarged portion of the alphanumeric or other character within the gesture recognition overlay, and periodically updating the display of the enlarged portion based on movement of the first touch event across the gesture recognition overlay. In another embodiment, the processor may be configured to perform operations further including recognizing a character sketched in the gesture recognition overlay, and adding the recognized character to the displayed text string at the updated cursor position. In another embodiment the processor may be configured to perform operations further includes detecting a user input corresponding to activation of a text selection mode, and highlighting the alphanumeric or other character when the text selection mode is activated. In another embodiment, the processor may be configured to perform operations further including detecting a user input corresponding to activation of a text selection mode, and highlighting a word in a direction of movement of the first touch event when the text selection mode is activated. In another embodiment, the processor may be configured to perform operations further including determining a speed of movement of the first user input, wherein determining an intended cursor movement within a displayed text string based on the detected first touch event includes determining that a single character movement of the cursor is intended when the speed of movement of the first user input is slow, and determining that a multi-character movement of the cursor is intended when the speed of the movement of the first user input is fast. In another embodiment the processor may be configured to perform operations further including displaying a menu of functions including one or more menu icons within the gesture recognition overlay in response to detecting a user input corresponding to activation of a toolbar functionality, detecting a user touch on one or more menu icons, and implementing a function corresponding to the touch one or more menu icons.

In further embodiments, a computing device includes means for displaying a translucent gesture recognition overlay area on a portion of the touchscreen display, means for detecting a first touch event on the touchscreen within the gesture recognition overlay, means for determining an intended cursor movement within a displayed text string based on the detected first touch event, means for determining an alphanumeric or other character adjacent to a current position of a cursor within the displayed text string after the determined intended cursor movement, means for displaying, on the touchscreen, an enlarged portion of the alphanumeric or other character, and means for updating the cursor position in the displayed text string. In a further embodiment the means for displaying a translucent gesture recognition overlay area on a portion of the touchscreen display includes means for displaying a translucent gesture recognition overlay area on a portion of the touchscreen display in response to detecting a user input corresponding to activation of a gesture recognition overlay functionality. In a further embodiment, the means for determining an intended cursor movement within a displayed text string based on the detected touch event includes means for determining from the first touch event whether a user has touched the gesture recognition overlay with a finger or stylus near an edge, and means for determining from motion of the first touch event whether the user has dragged the finger or stylus towards the opposite edge of the gesture recognition overlay along a centerline. In a further embodiment, the means for displaying, on the touchscreen, an enlarged portion of the alphanumeric or other character includes a means for displaying an enlarged portion of the alphanumeric or other character within the gesture recognition overlay, and means for periodically updating the display of the enlarged portion based on movement of the first touch event across the gesture recognition overlay. In another embodiment, the computing device further includes means for recognizing a character sketched in the gesture recognition overlay, and means for adding the recognized character to the displayed text string at the updated cursor position. In another embodiment, the computing device further includes means for detecting a user input corresponding to activation of a text selection mode, and means for highlighting the alphanumeric or other character when the text selection mode is activated. In another embodiment, the computing device further includes means for detecting a user input corresponding to activation of a text selection mode, and means for highlighting a word in a direction of movement of the first touch event when the text selection mode is activated. In another embodiment, the computing device further includes means for determining a speed of movement of the first user input, wherein the means for determining an intended cursor movement within a displayed text string based on the detected first touch event includes means for determining that a single character movement of the cursor is intended when the speed of movement of the first user input is slow, and means for determining that a multi-character movement of the cursor is intended when the speed of the movement of the first user input is fast. In another embodiment, the computing device further includes means for displaying a menu of functions that includes one or more menu icons within the gesture recognition overlay in response to detecting a user input corresponding to activation of a toolbar functionality, means for detecting a user touch on one or more menu icons, and means for implementing a function corresponding to the touch one or more menu icons.

In further embodiments, a non-transitory computer-readable storage medium has stored thereon processor-executable instructions that are configured to cause a processor of a computing device equipped with a touchscreen display to perform operations including displaying a translucent gesture recognition overlay area on a portion of the touchscreen display, detecting a first touch event on the touchscreen within the gesture recognition overlay, determining an intended cursor movement within a displayed text string based on the detected first touch event, determining an alphanumeric or other character adjacent to a current position of a cursor within the displayed text string after the determined intended cursor movement, displaying on the touchscreen an enlarged portion of the alphanumeric or other character, and updating the cursor position in the displayed text string. In a further embodiment, the stored processor-executable instructions are configured such that displaying a translucent gesture recognition overlay area on a portion of the touchscreen display is accomplished in response to detecting a user input corresponding to activation of a gesture recognition overlay functionality. In a further embodiment, the stored processor-executable instructions are configured such that determining an intended cursor movement within a displayed text string based on the detected touch event includes determining from the first touch event whether a user has touched the gesture recognition overlay with a finger or stylus near an edge, and determining from motion of the first touch event whether the user has dragged the finger or stylus towards the opposite edge of the gesture recognition overlay along a centerline. In a further embodiment, the stored processor-executable instructions are configured such that displaying, on the touchscreen, an enlarged portion of the alphanumeric or other character includes displaying an enlarged portion of the alphanumeric or other character within the gesture recognition overlay, and periodically updating the display of the enlarged portion based on movement of the first touch event across the gesture recognition overlay. In another embodiment, the stored processor-executable instructions are configured to cause a computing device processor to perform operations further including recognizing a character sketched in the gesture recognition overlay, and adding the recognized character to the displayed text string at the updated cursor position. In another embodiment, the stored processor-executable instructions are configured to cause a computing device processor to perform operations further including detecting a user input corresponding to activation of a text selection mode, and highlighting the alphanumeric or other character when the text selection mode is activated. In another embodiment, the stored processor-executable instructions are configured to cause a computing device processor to perform operations further including detecting a user input corresponding to activation of a text selection mode, and highlighting a word in a direction of movement of the first touch event when the text selection mode is activated. In another embodiment, the stored processor-executable instructions are configured to cause a computing device processor to perform operations further including determining a speed of movement of the first user input, wherein determining an intended cursor movement within a displayed text string based on the detected first touch event includes determining that a single character movement of the cursor is intended when the speed of movement of the first user input is slow, and determining that a multi-character movement of the cursor is intended when the speed of the movement of the first user input is fast. In another embodiment, the stored processor-executable instructions are configured to cause a computing device processor to perform operations further including displaying a menu of functions including one or more menu icons within the gesture recognition overlay in response to detecting a user input corresponding to activation of a toolbar functionality, detecting a user touch on one or more menu icons, and implementing a function corresponding to the touch one or more menu icons.

### BRIEF DESCRIPTION OF THE DRAWINGS

The accompanying drawings, which are incorporated herein and constitute part of this specification, illustrate exemplary aspects of the invention. Together with the general description given above and the detailed description given below, the drawings serve to explain features of the invention.

FIG. 1 is a frontal view of a mobile device illustrating an embodiment gesture recognition overlay in a text composition application on a touchscreen display.

FIGS. 2A and 2B are frontal views of a touchscreen display illustrating an embodiment in a text composition application responding to user input gestures on a gesture recognition overlay.

FIG. 3 is a process flow diagram of an embodiment method for moving a text cursor in response to a user input gesture on a gesture recognition overlay.

FIGS. 4A and 4B are frontal views of a mobile device touchscreen display showing a text composition application responding to a user input gesture to display a toolbar on the gesture recognition overlay.

FIGS. 5A, 5B, and 5C are frontal views of a mobile device touchscreen display showing different responses to various user input gestures on a gesture recognition overlay.

FIG. 6 is a process flow diagram of an embodiment method for selecting text in response to a user input gesture on a gesture recognition overlay.

FIG. 7 is a process flow diagram of an embodiment method for implementing a tool bar menu on a gesture recognition overlay.

FIG. 8 is a component block diagram of an example portable computing device suitable for use with the various aspects.

### DETAILED DESCRIPTION

The various aspects will be described in detail with reference to the accompanying drawings. Wherever possible, the same reference numbers will be used throughout the drawings to refer to the same or like parts. References made to particular examples and implementations are for illustrative purposes and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

The terms “computing device” and “mobile device” are used interchangeably herein to refer to any one or all of cellular telephones, personal data assistants (PDA's), palm-top computers, wireless electronic mail receivers (e.g., the Blackberry® and Treo® devices), multimedia Internet enabled cellular telephones (e.g., the Blackberry Storm®), Global Positioning System (GPS) receivers, wireless gaming controllers, personal computers, and similar personal electronic devices which include a touchscreen user interface/display. While the various embodiments are particularly useful in mobile devices, such as cellular telephones, which have small displays, the embodiments may also be useful in any computing device that employs a touchscreen display or a touch surface user interface. Therefore, references to “mobile device” in the following embodiment descriptions are for illustration purposes only, and are not intended to exclude other forms of computing devices that feature a touchscreen display or to limit the scope of the claims.

The various embodiments provide a gesture recognition overlay for a mobile device that enables useful user interface functionality. A mobile device configured with such an overlay functionality may provide users with the ability to enter alphanumeric text and edit text by performing simple gestures on a gesture recognition overlay within the touchscreen display. By providing a larger area for accepting user input touch gestures as well as presenting menus, the various embodiments facilitate text entry and editing operations on the relatively small area of most mobile device touch screen displays. While the various embodiments are illustrated in use with a text entry application, the embodiments are not limited to text applications or the manipulation of text fields, and may be implemented with a wide range of applications including multimedia editing and display, games, communication, etc.

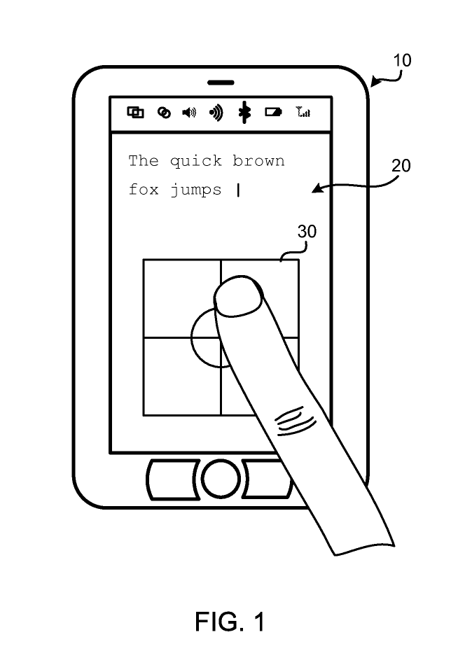

FIG. 1 illustrates an example mobile device 10 equipped with a touchscreen 20 and configured with a gesture recognition overlay 30 executing in conjunction with an application. The mobile device 10 may be loaded with one or more applications which may accept alphanumeric text entry. For example, the mobile device 10 may be programmed with an email application that allows users to compose an email message. Such an application may generate a virtual keyboard (not shown) to enable users to enter alphanumeric characters by tapping icons displayed on the touchscreen 20 corresponding to that character. The various embodiments provide an alternative or addition user interface that allows users to enter or edit text, as well as perform other tasks, by touching, tapping, and sliding finger or stylus touches within a gesture recognition overlay 30.

The gesture recognition overlay 30 may be configured as an image presented on the touch screen display that has functionality related to the zones of the display that are touched and the directions in which a touch is dragged. In some embodiments the gesture recognition overlay 30 may be presented as a semi-transparent screen or translucent overlay through a technique known as “alpha blending” so that underlying parts of the displayed image can be viewed. The embodiments include configuring the mobile device to recognize certain touch events within the gesture recognition overlay 30 as corresponding to defined user interface commands. Such recognized commands may be, for example, the entry of letters, numbers, punctuation marks, special characters (e.g., mood-icons) and common strings (e.g., “www.” and “.com”) that are traced within the area of the gesture recognition overlay 30. For ease of reference, letters, numbers, punctuation marks, special characters (e.g., mood-icons) and common strings (e.g., “www.” and “.com”) are referred herein generally as characters. The recognized commands may also include actions associated with text entry, such as the backspace action, cursor movements, text highlighting, and text moving. The overlay may be configured with defined edges represented by a border of contrast-colored pixels, or simply by the boundary between the overlay 30 and the underlying application. The overlay 30 may include sub-portions defined by contrast-colored pixels along two centerlines (i.e., the horizontal and the vertical). The overlay 30 may further include contrast-colored pixels in a circular pattern around the center of the overlay, to define a center region. The overlay 30 may further be configured to display magnified portions of a display or text that is being addressed by user interactions on the overlay.

In a simple example of interaction with a gesture recognition overlay 30, if the user makes a circular motion inside the overlay 30, the mobile device may recognize this gesture as an entry of the letter “O” as if typed on a key of a virtual keyboard. Similarly a vertical swipe through the overlay 30 may be recognized as entry of a “1” or an “i”. The larger size and fixed boundaries of the gesture recognition overlay 30 may facilitate the entry and recognition of letters and numbers from lines and curves traced within the overlay area by the tip of a finger or stylus.

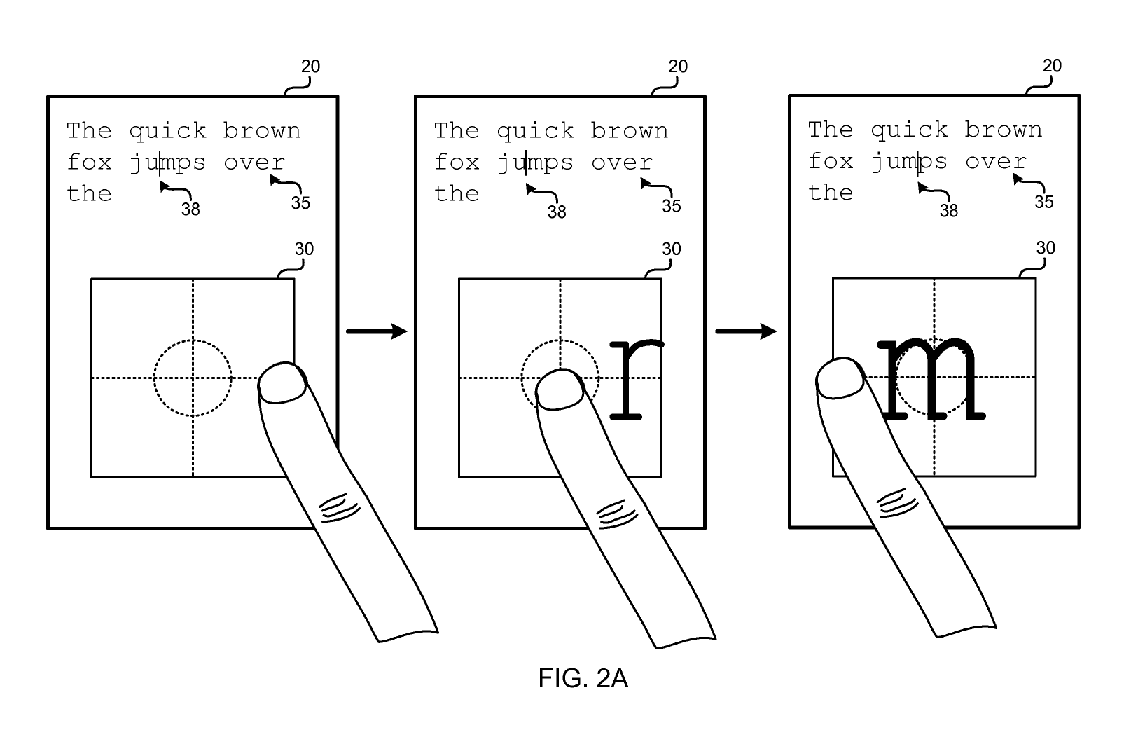

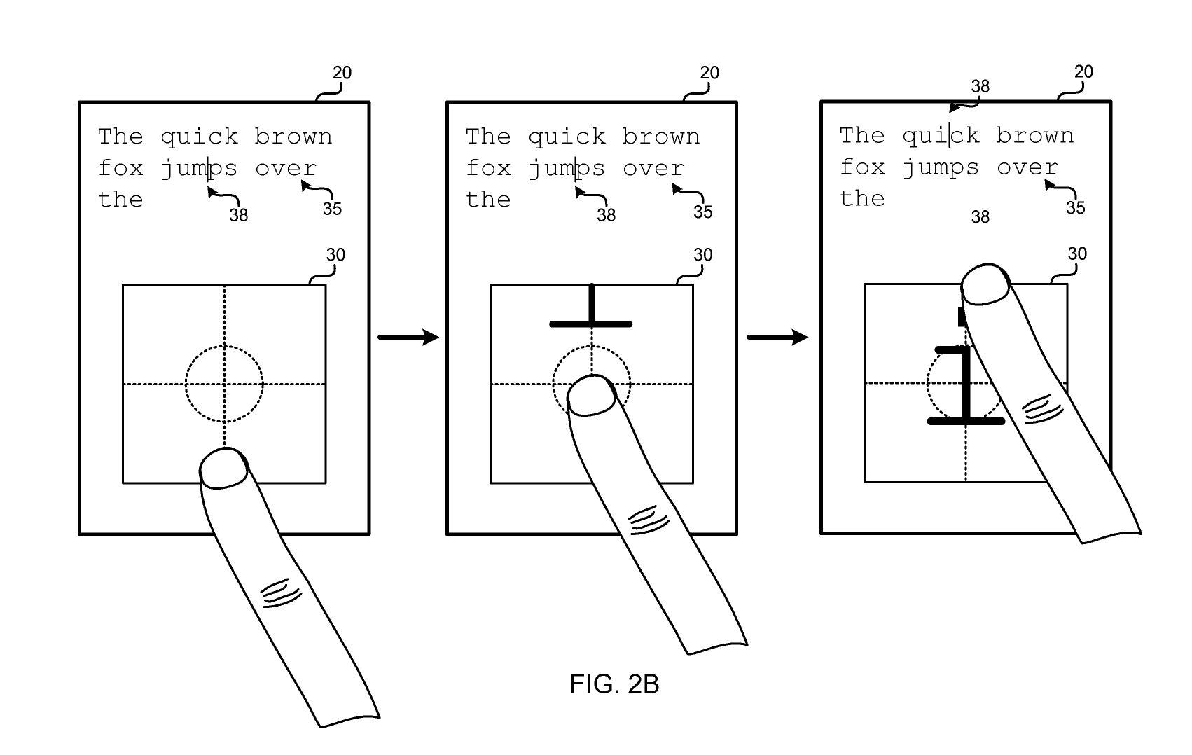

In addition to providing gesture recognition for alphanumeric text entry, gesture recognition overlay 30 may provide for the recognition of action gestures, such as a gesture to backspace or move the cursor. Examples of such embodiments in operation are illustrated in FIGS. 2A and 2B. In the illustrated examples, the mobile device has an active text input function (e.g., an email composition application) that includes a string buffer for storing and displaying a current a string of text 35. The text input function may further include displaying a cursor 38 which denotes the position within the text string 35 where new text will be inserted. In the example shown in FIG. 2A, a user may move the cursor position horizontally by dragging a finger or stylus horizontally along a centerline of the overlay 30 from one edge to the other. The movement gesture may be defined by distance threshold values, such as a movement that begins with the user placing a finger or stylus within first threshold distance of the intersection of a centerline and an edge and dragging the finger or stylus for at least a second threshold distance in the direction of the opposite edge and for no more than a third threshold distance in a direction perpendicular to the centerline (i.e., the movement may be required to be almost entirely horizontal or vertical). In various implementations such threshold distances may be measured in terms of screen pixels, although the pixel density will vary from device to device, percentages of the display or overlay width/height, or conventional distance units (e.g., millimeters). In some embodiments, the direction of movement of the cursor compared to the direction of movement of the finger or stylus may be inverted, such that a left to right movement gesture moves the cursor to the left.

In some embodiments, the touchscreen overlay may assist the user in moving a cursor within a text field by providing a magnification of the text field within the overlay. Two examples of such cursor movement functionality according to an embodiment are shown in FIGS. 2A and 2B. In response to recognizing the beginning of a movement gesture, the overlay 30 may access a position of the string buffer associated with a portion of the text string 35 adjacent to the cursor 38 and display an enlarged version of the text string within the overlay 30.

FIG. 2A illustrates an example functionality of the overlay 30 to position the cursor 38 through a horizontal touch gesture. In the example shown in FIG. 2A, the user is performing a left to right movement of a finger or stylus tip across the overlay 30, which the mobile device recognizes as a command to move the cursor causing it roll across the “m” character in the word “jumps.” As the cursor is moved in step with the finger or stylus tip movement, the overlay 30 displays a magnified portion of the text string including the letter “m.” At the completion of the finger or stylus tip movement, the letter “m” is displayed in the overlay 30, indicating that this letter is highlighted in the application. It should be appreciated that while this example illustrates the cursor moving in the same direction as the an left-to-right finger/stylus movement, the functionality response may be the opposite, namely moving in the opposite direction of the finger/stylus movement. Further, the direction of the cursor's movement may be a user-configurable parameters, such as defined in a user preference setting.

FIG. 2B illustrates an example functionality of the overlay 30 to position the cursor 38 through a vertical touch gesture. In the example shown in FIG. 2B, the user is performing a up to down movement of a finger or stylus tip across the overlay 30, which the mobile device recognizes as a command to move the cursor up causing it highlight the “i” character in the word “quick.” As the cursor is moved in step with the finger or stylus tip movement, the overlay 30 displays a magnified portion of the text string including the letter “i.” At the completion of the finger or stylus tip movement, the letter “i” is displayed in the overlay 30, indicating that this letter is highlighted in the application. It should be appreciated that while this example illustrates the cursor moving up in response to an up-to-down finger/stylus movement, the functionality response may be the opposite, namely moving down in response to an up-to-down finger/stylus movement. Further, the direction of the cursor's movement may be a user-configurable parameters, such as defined in a user preference setting.

FIGS. 2A and 2B illustrate cursor movement functionality in response to a finger or stylus drag movement. Similar functionality may be implemented for flick gestures, in which the user's finger or stylus travels quickly across the gesture recognition overlay as if flicking something off the display. In this flick gesture functionality, the cursor is moved multiple positions, with the distance determined based upon the speed of flick gesture.

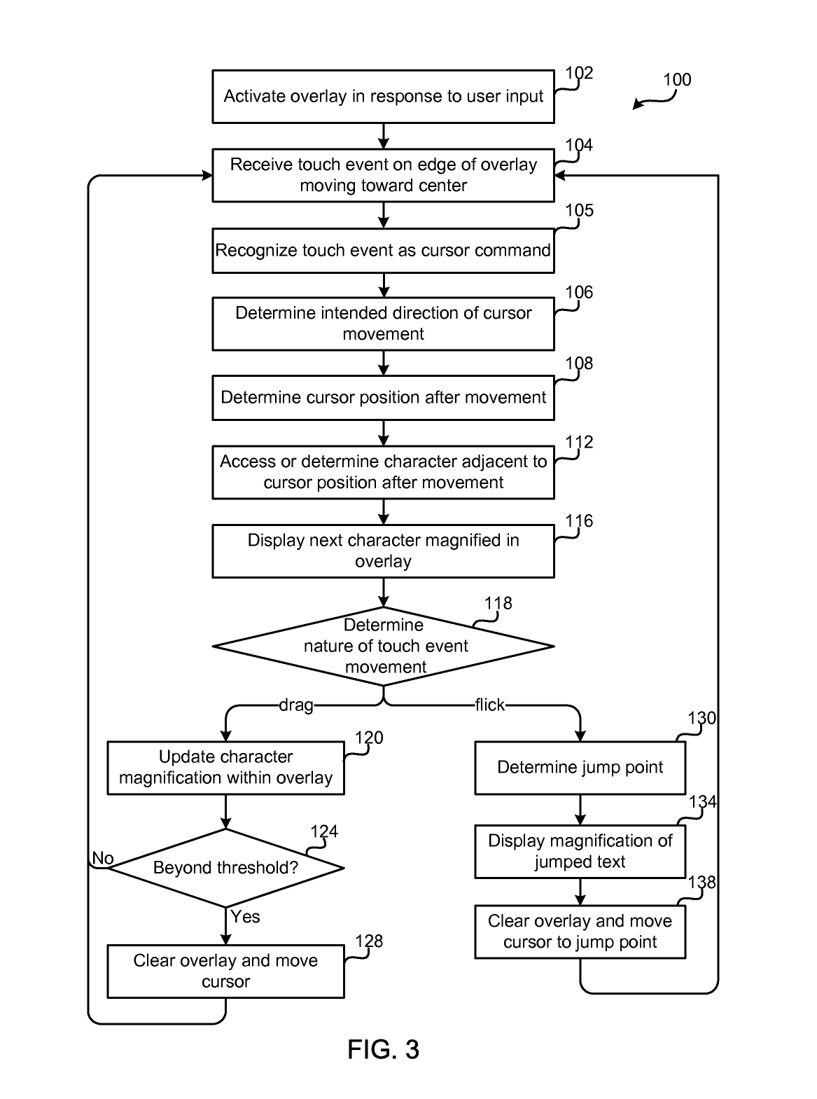

An example method 100 that may be implemented in a processor of a mobile device for causing a cursor movement in response to a touch gesture within a gesture recognition overlay is illustrated in FIG. 3. In method 100 at block 102, the user may activate the gesture recognition overlay functionality. In various embodiments, the overlay may be activated by tapping a key icon on the touchscreen, touching a particular portion of the touchscreen display or pressing a physical button on the mobile. At block 104, the gesture recognition overlay functionality may receive a message from the operating system that a touch event has occurred within the coordinates of the gesture recognition overlay display. In some embodiments, the overlay may define threshold values for where a touch event is detected or where a touch movement gesture may begin. For example, the overlay functionality may recognize a cursor movement command when the touch gesture falls within 5 pixels or three millimeters of any intersection of a centerline and an edge and moves towards the center for at least 10 pixels or six millimeters.

At block 105, the processor may evaluate the received touch event to determine whether the user is entering a character or a cursor command. Entry of the character may be recognized based upon the starting point direction and curvilinear nature of the touch gesture. The gesture recognition overlay functionality may be configured with processor-executable instructions to recognize only certain touch events as being associated with cursor movements. In an embodiment, cursor movement commands are limited to beginning at a side of the overlay roughly adjacent to even the horizontal or vertical centerline. Thus, if a touch gesture begins at a location away from a side or top edge of the overlay adjacent to a horizontal or vertical centerline, the gesture recognition overlay functionality may be configured to recognize such a touch event as being associated with a character entry or some other functionality. Thus, character input patterns may be limited or defined so that such inputs do not begin near a centerline and/or along an edge of the overlay. If the processor executing the gesture recognition overlay functionality determines that the touch event is a character entry, the character recognized based on the pattern drawn on the overlay may be added to the text string at the current location of the cursor.

If the processor executing the gesture recognition overlay functionality determines that the touch event is not associated with the cursor command, the functionality may process the locations of the touch event against character recognition patterns in order to recognize a character being input by the user. Methods of recognizing patterns traced on a user input device are well known and may be implemented with the gesture recognition overlay serving as the input area for tracing such patterns. In this regard, the gesture recognition overlay functionality enables entry of such character tracings without confusing the user interface since touch events occurring within the overlay are interpreted by the processor as being user inputs to the functionality. Thus, even though user input icons and images below the overlay may be viewable through its translucent display, touch events within the overlay will not be interpreted as activation of any of the underlying user input icons.

At block 106, the mobile device processor may determine the direction of the intended cursor movement based on movements of the touch coordinates received from the operating system. In some embodiments, if the user moves his or her finger or stylus left to right horizontally, this indicates an intention to move the cursor to the left. Alternately, in some embodiments a left to right horizontal movement may be used to move the cursor to the right. In a further embodiment, the movement direction may be user-configurable. Similarly, vertical finger or stylus movement may be interpreted as a request to move the cursor up or down. At block 108, the processor may determine the cursor position after a one-character movement. For example, if the cursor is between character 37 and character 38 in a string buffer and the processor has determined that the user wishes to move the cursor to the right, then the position of the cursor after the movement may be between characters 38 and 39. Alternatively, if the user wishes to move the cursor upwards, the final cursor position may be between characters 26 and 27.

At block 112, the processor may determine the alphanumeric, punctuation mark or other character adjacent to the cursor position after the cursor movement by accessing the string buffer. In some embodiments, the magnification aspect may simulate the viewpoint of the cursor by displaying the character over which the cursor is moving, as is illustrated in FIG. 2A. In the example shown in FIG. 2A, the processor may access the “m” character in the string buffer which is adjacent to both the start and end positions of the cursor 38. In the example shown in FIG. 2B, the overlay 30 may access the character to the right of the cursor position for vertical cursor movement. At block 116, the processor may display the magnified character or a portion thereof within the overlay. As is shown in the middle frame of FIG. 2A, the initial display of the magnified character may be a partial display positioned near the edge of the overlay 30.

As described above with reference to FIG. 2A, the mobile device may move the magnified character within the overlay 30 as the user continues to move a finger or stylus toward the opposite edge of the overlay 30. To accomplish this, at determination block 118, the processor may determine whether the touch event is moving and the nature of the movement. If the user continues to slowly drag a finger or stylus tip slowly across the overlay (i.e., determination block 118=“Drag”), the processor may update the display character magnification displayed within the overlay at block 120. At determination block 124, the processor may determine whether the user has dragged a finger or stylus tip beyond a threshold distance (e.g., a minimum number of pixels or millimeters) sufficient to disambiguate the touch gesture as a cursor movement gesture. If the distance threshold has been met by the touch gesture (i.e., determination block 124=“Yes”), then the processor may move the cursor to the location determined at block 108 and clear the display to place the overlay in the base state capable of accepting additional gestures such as those relating to text entry described above with reference to FIG. 1. Once the cursor movement has been completed, gesture recognition overlay functionality may return to block 104 to receive the next touch event from the operating system.

In some embodiments, the gesture recognition overlay functionality may enable jumping the cursor over several characters or spaces, similar to the jump scrolling or flick scrolling feature common on touchscreen user interfaces. In such embodiments, the processor may be configured to recognize a “flick” gesture, such as by detecting that the finger or stylus no longer touches the touchscreen and detecting that the finger or stylus was moving at the moment that the finger or stylus stopped touching the touchscreen. If the processor determines that the nature of the touch event movement indicates a flick of the finger or stylus tip from the edge of the overlay towards the center (i.e., determination block 118=“Flick”), the processor may determine the position of the cursor after the jump (i.e., the jump point) at block 130. The amount of text jumped in response to such a flick gesture may be determined based on the measured tangential velocity of the movement of the finger or stylus tip across the overlay at the that the finger or stylus stopped touching the touchscreen. Alternatively, the amount of text jumped in response to a flick gesture may be fixed at a certain number of pixels, millimeters, characters, spaces or lines. In another embodiment, a horizontal flick gesture (i.e., a rapid movement more or less parallel to the horizontal centerline of the overlay) may be construed as a command to move the cursor to the beginning or end of the line. Similarly, a vertical flick gesture (i.e., a rapid movement more or less parallel to the vertical centerline of the overlay) may be construed as a command to perform a page up or page down movement through a text document. Once the jump point is determined at block 130, processor may display a scrolling magnification of the jumped text starting with the character already displayed in the overlay at block 134 so that the overlay shows a continuous stream and movement of magnified characters moving across the overlay during the flick movement. At the jump end point the processor may clear the overlay magnification and return the overlay to the base state in block 138. Alternatively, the mobile device may clear the overlay magnification and instead magnify characters adjacent to the cursor at the jump end point. Once the cursor movement has been completed, gesture recognition overlay functionality may return to block 104 to receive the next touch event from the operating system.

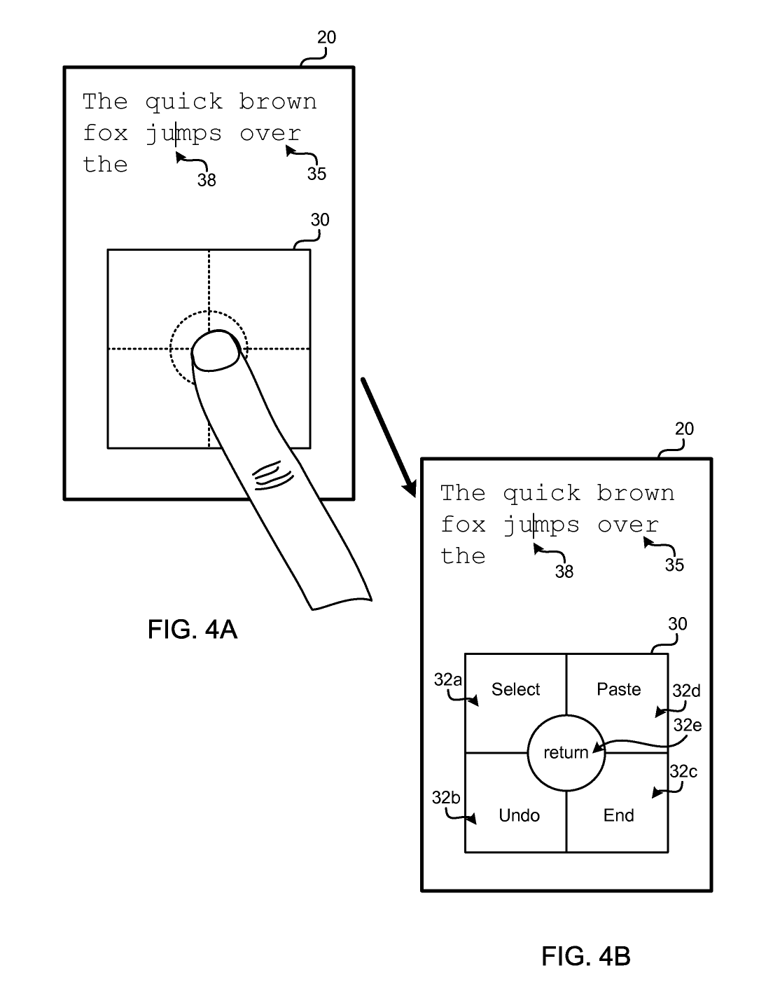

In some embodiments, the gesture recognition overlay functionality may provide an additional or alternative operating mode in which the overlay becomes or displays a toolbar with a plurality of virtual buttons (i.e., user input icons displayed within the overlay). An example of such an embodiment is illustrated in FIGS. 4A and 4B, which shows the output of a mobile device touchscreen 20 as an overlay 30 progresses through multiple states. FIG. 4A shows the overlay 30 in the base state for receiving gestures corresponding to actions (e.g., cursor movement) or alphanumeric text entry into a text string 35 stored in a string buffer with the input location indicated by the cursor 38. In this embodiment, the gesture recognition overlay functionality may provide a user input gesture for entering into a toolbar state, such as touching the center location of the overlay 30. This is illustrated in FIG. 4A which shows the user tapping within a circle centered inside the overlay 30. In response to this toolbar gesture, the overlay 30 may enter a toolbar state which displays a series of toolbar icon buttons 32a-32e illustrated in FIG. 4B. The toolbar icon buttons 32a-32e may be predefined or based on user preference settings. Toolbar icon buttons 32a-32e may depend upon the current operating state, application or condition within the current application (i.e., dynamic). For example, a particular button 32d may be linked to a paste function when there is data in the clipboard buffer suitable for being inserted in the instant application, and link to a copy function when text is selected (i.e., highlighted) in the text string 35 suitable for being copied in the application. Such dynamic buttons may include labels linked to be implemented functionality, so that the user knows which dynamic function is currently assigned to the displayed button icon. The toolbar-mode overlay 30 may also provide a return button 32e for exiting the toolbar mode and returning to the base state of the gesture recognition overlay functionality.

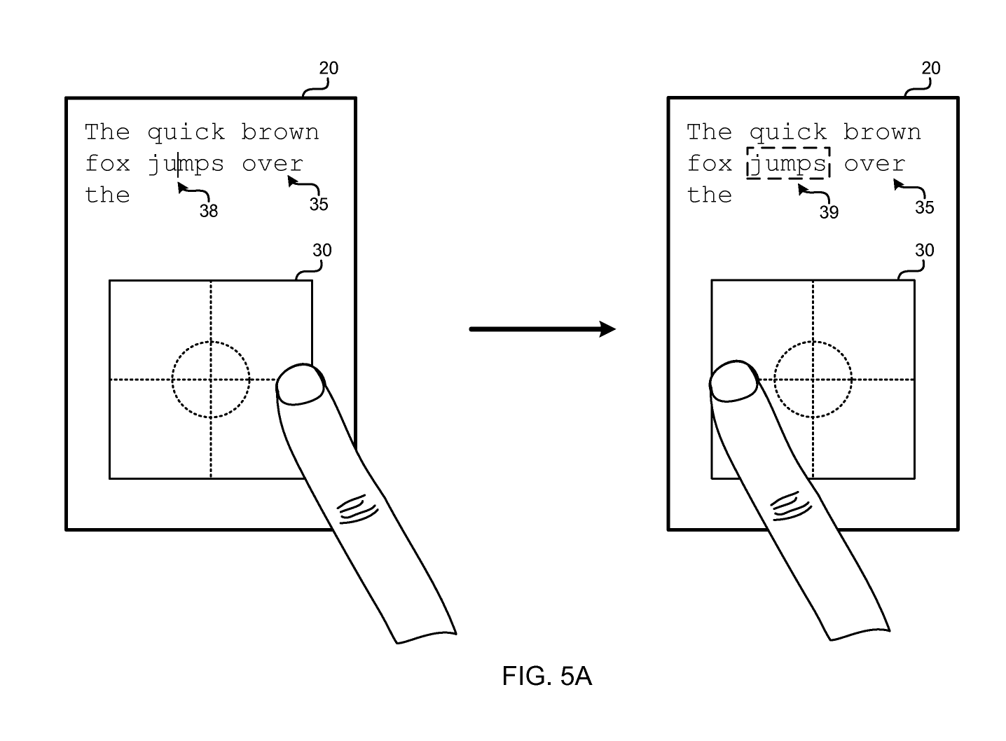

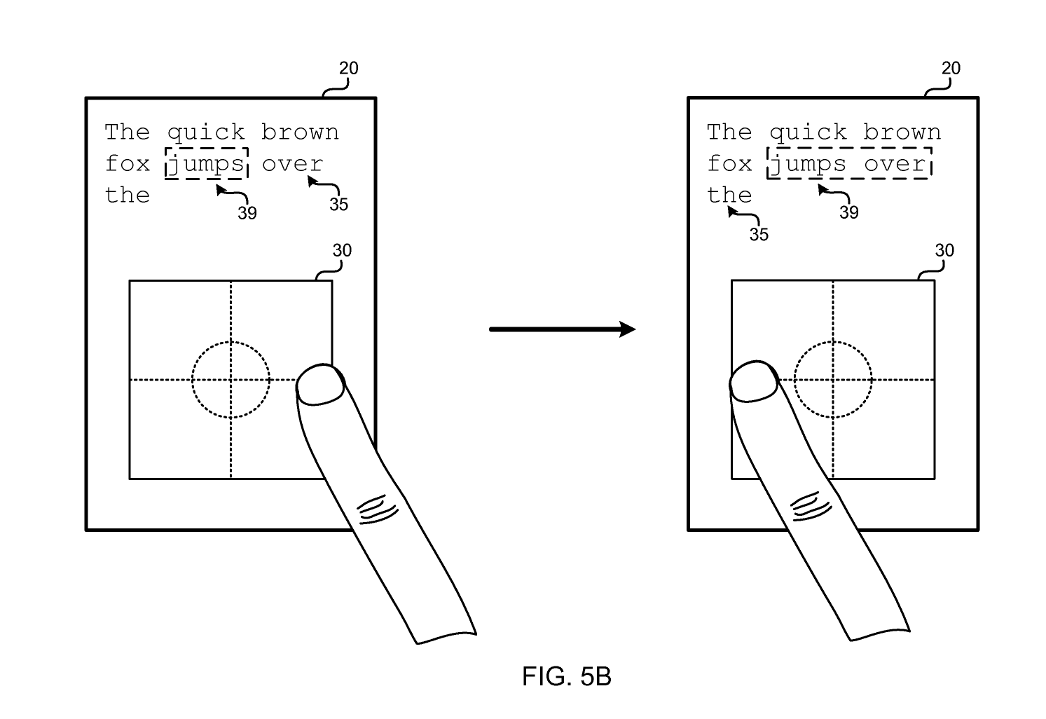

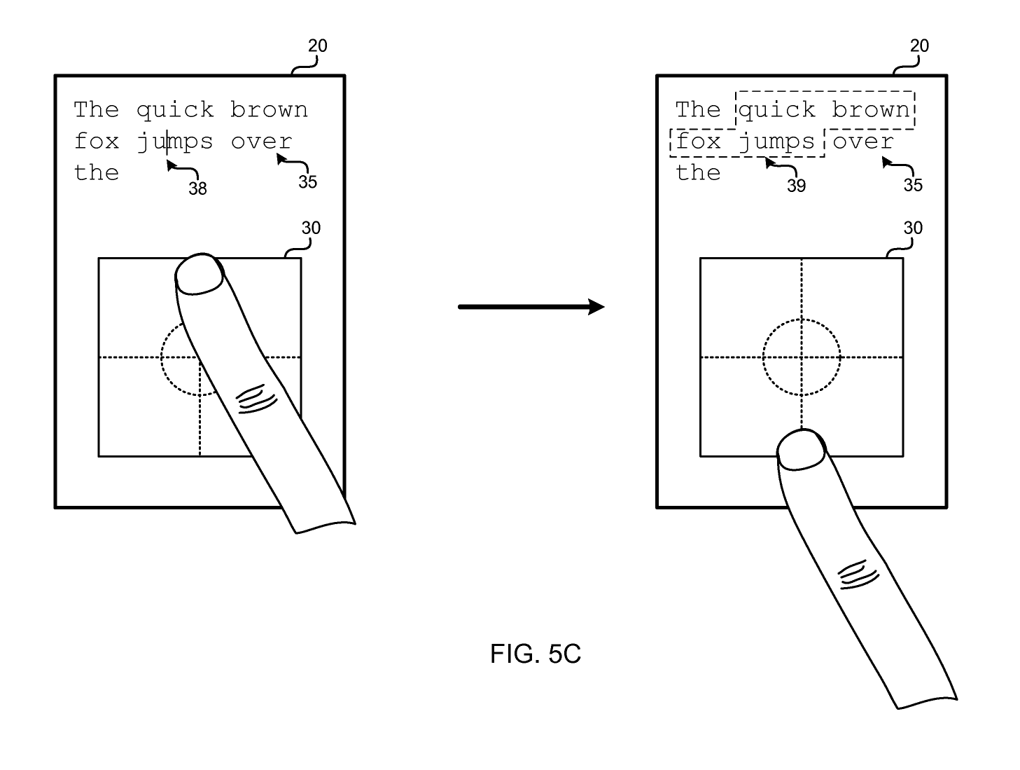

The toolbar-mode overlay 30 may also provide a select button 32a function to enter a text selection mode, in which the overlay may be used to select portions of the text string 35. Examples of text selection functionality that may be included in such a text selection mode are illustrated in FIGS. 5A, 5B, and 5C, which show displays of a mobile device touchscreen 20 as an overlay 30 responds to various gestures. The selection-mode overlay 30 may enable a user to select text by recognizing touch gestures similar to the cursor movement gestures described above with reference to FIGS. 2A, 2B, and 3. The selection-mode overlay 30 may enter selection mode with a cursor 38 inside a text string 35 stored in a text buffer. As shown in FIG. 5A, in the selection mode the overlay 30 may respond to a horizontal movement gesture by copying the word encompassing the cursor 35 into a highlight buffer, such as highlighted text string 39, or other mechanism for highlighting the selected characters. If the cursor 38 is not within a word (e.g., the cursor is adjacent to a space character), the overlay 30 may highlight the word to the right or left of the cursor 38. Alternatively, the selection-mode overlay 30 may highlight a single character at a time as the cursor passes over the character in response to a horizontal movement gesture.

FIG. 5B illustrates another example in which the selection mode may append words to or remove words from the highlighted text string 39 in response to further moving touch gestures if a portion of highlighted text string 39 is already highlighted. In an embodiment, the highlighting applied to a first selected word may be a slightly different shade than the highlight applied to subsequent words so that the user may easily recognize which direction the highlighted text string 39 is growing. In the example shown in FIG. 5B in which the word “jumps” was selected first, a finger or stylus tip movement to the right may add the word “the” to the highlighted text string 39, while a movement to the left may remove the word “over” from the highlighted text string 39. Similarly, if “over” was the first word selected, then a movement to the right may remove the word “jumps” from the highlighted text string 39, while a movement to the left may prepend the word ‘fox’ to the highlighted text string 39. An embodiment in which the original word is indicated may reduce user error. The boundaries of the highlighted text string 39 may be referred to as the fixed boundary and the variable boundary, which may be related to memory values in a highlight buffer. In some overlay embodiments, the text selection mode may also incorporate the magnification and flicking aspects described above with respect to FIGS. 2A, 2B, and 3 so some or all of the selected text appears magnified within the overlay 30.

FIG. 5C illustrates a further example of highlighting functionality in which a vertical movement gesture may highlight the substring bounded by the word at the current cursor position and the word above or below the current cursor position. In a further embodiment, the highlight can be grown (extended) or shrunk by means of a finger/stylus directly touching at a particular location of the text. Also, if the finger or stylus directly touches and holds at a particular portion of the text, the finger or stylus can continue to drag (extend or shrink) the highlight. During the such a dragging movement, the overlay may shrink to a stamp size so that the dragging can access the text that normally is covered by the overlay. Touching the stamp size overlay with a finger or stylus may expand the overlay to its normal size and position.

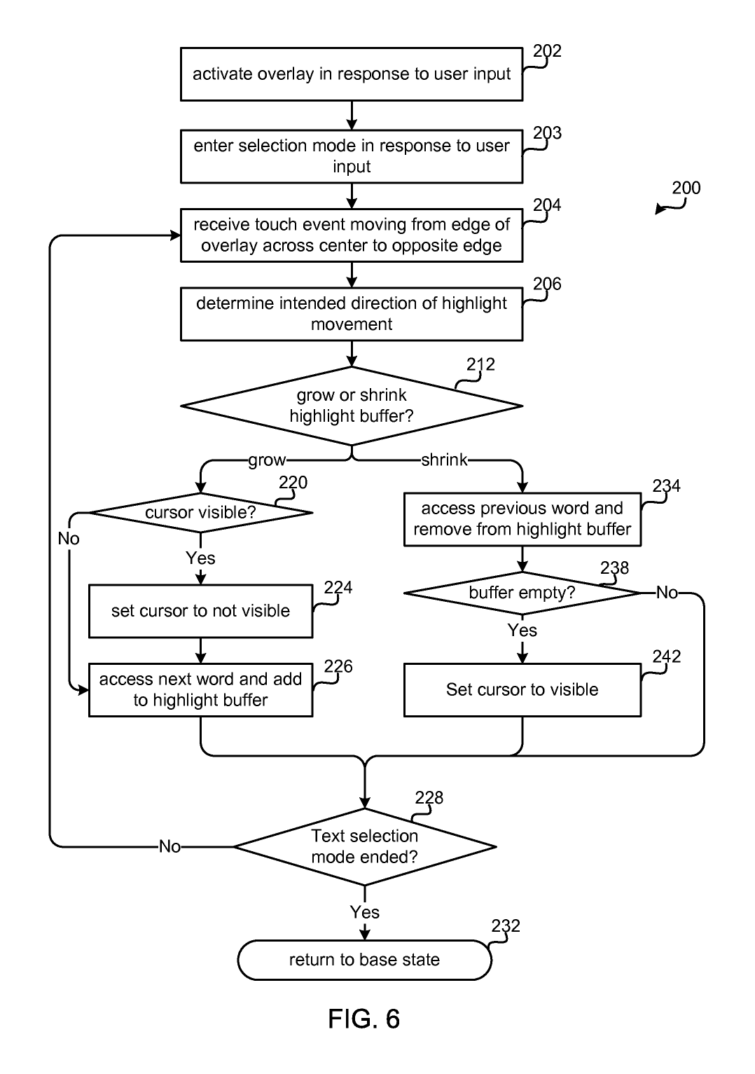

An exemplary method 200 for providing text selection functionality in an overlay is illustrated in FIG. 6, which shows process steps that may be implemented on a touchscreen-equipped mobile device. The mobile device may activate the overlay in response to a user input at block 202, such as receiving a user tap on an overlay button on a virtual touchscreen keyboard. The processor may enter a selection mode of the gesture recognition overlay functionality in response to the received user input at block 203, such as the user tapping the corresponding selection button icon while the overlay is in toolbar mode. In an alternative embodiment, the processor may enter a selection mode of the gesture recognition overlay functionality in response to a finger or stylus double tapping a word on the display. In response to a double tap on a word, the word that is doubled-tapped may be highlighted. Further, if the user double-tapped on an empty space, the word closest to the empty space may be highlighted.

At block 204, the processor may receive a touch event indicating that the user has dragged a finger or stylus along an overlay center line from one edge of the overlay to the other edge (i.e., a movement gesture). At block 206, the processor may determine the intended direction of the movement based upon the coordinates of the touch event received in block 204. In an embodiment, a right to left touch movement gesture may be correlated to a command causing the variable highlight buffer boundary to move to the left. Alternatively, a right to left movement may be correlated to a command causing the variable highlight buffer boundary to move his to the right (i.e., inverted control). Both or either of the horizontal and vertical movement gestures may be inverted, but neither need be.

At determination block 212, the processor may determine whether the indicated movement of the variable boundary will grow or shrink the highlighted text stored in the highlight buffer. If the processor determines that the touch event movement corresponds to a command to grow the highlighted text by adding text to the highlight buffer (i.e., determination block 212=“Grow”), the processor may determine whether the cursor is visible in the display at determination block 220. In one embodiment, the cursor will be visible when the highlight buffer is empty. In another embodiment there may be no cursor at all times, and instead the user will see a highlight. The presence and absence of a cursor versus a highlight may render it obvious to the user whether the user interface is in a selection mode or in a cursor (regular) mode. Thus, in this embodiment a cursor may never appear during the selection mode nor will a highlight ever disappear. The smallest unit that a highlight will cover is a “word,” which can be just a single character like “a” or “I”. If the cursor is visible (i.e., determination block 220=“Yes”), the processor may set the cursor to not be visible in block 224. The processor may access the next word (or character in an embodiment where the boundary moves one character at a time) and add it to the highlight buffer at block 226. If the processor determines that movement of the variable boundary in response to the moving touch gesture will shrink the highlighted text string stored in the highlight buffer (i.e., determination block 212=“Shrink”), the processor may access the previously added word (i.e., the word adjacent to the variable boundary), and remove it from the highlight buffer at block 234. Removing the selected word from the highlight buffer will cause the display of word to shift to normal (i.e., non-highlighted) mode. Alternatively, the user may command an exit from the highlight mode by performing a predefined user touch gestures, such as tapping on the center circle of the overlay to display a tool bar and then selecting another function (e.g., unselect, cut, copy, paste, etc.), or double tapping on the highlight. At determination block 238, the processor may determine whether the highlight buffer is empty. If the highlight buffer is empty (i.e., determination block 238=“Yes”), the processor may set the cursor back to visible at block 242.

After adding or deleting a word from the highlight buffer, the processor may determine whether the text selection mode is ended at determination block 228. This determination may be based upon the defined actions that terminate the text selection mode, such as a period of time of inactivity, tapping on a menu icon, activating another functionality by tapping on the center circle and selecting another function, double tapping on the highlight, etc. For example, the text selection mode may terminate when the user taps the center of the overlay to bring up the overlay toolbar. As another example, the text selection mode may terminate when the user performs a “cut” command (e.g., performing a gesture which causes the processor to move the content of the highlight buffer to the clipboard buffer). If the processor determines that the text selection gesture is complete (i.e., determination block 228=“Yes”), the processor may return the overlay to the base state at block 232. If the processor determines that the text selection gesture is not complete (i.e., determination block 228=“No”), the mobile device may wait for another touch movement gesture input from the operating system in block 204.

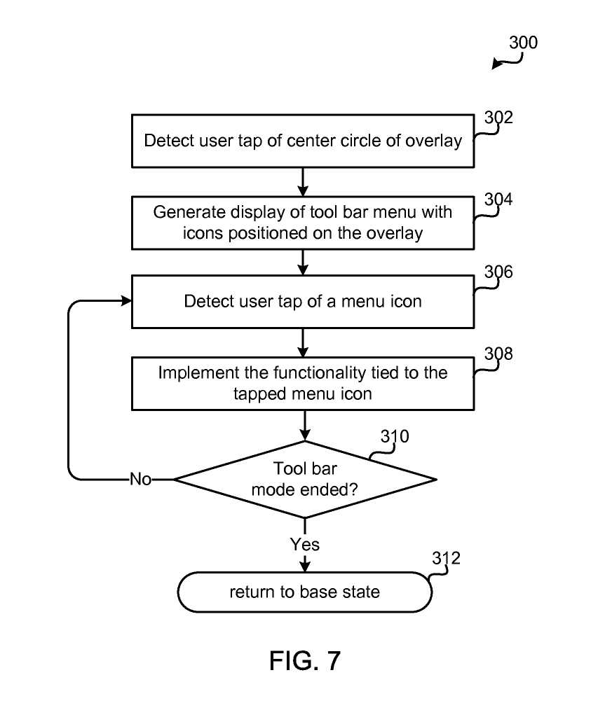

An example method 300 for implementing a toolbar within the gesture recognition overlay is illustrated in FIG. 7. In method 300 at block 302, the processor may detect a user tap of the center circle of the overlay. This detection may be accomplished based upon the touchscreen coordinates of a touch event reported by the mobile device operating system. At block 304, the processor may modify the overlay display to generate a display of toolbar and menu with icons position within the overlay, such as in the four corners of the overlay. At block 306, the processor may detect a user tap of one of the menu icon, and at block 308, the processor may implement the functionality tied to the attached a menu icon. At determination block 310, the processor may determine whether the toolbar mode has ended. This determination may be based upon defined actions that terminate the toolbar mode, such as a period of time of inactivity, tapping on any menu icon, activating another functionality, etc. If the toolbar mode has not ended (i.e., determination block 310=“No”), the processor may return to block 306 to receive the next user input on the toolbar. Once the toolbar mode has ended (i.e., determination block 310=“Yes”), the processor may return the gesture recognition overlay to the base state at block 312.

The foregoing embodiment descriptions illustrate some of the user input functionality that may be implemented in a gesture recognition overlay. Other functionality may be implemented in a similar manner. For example, different functionality may be associated with diagonal motions through the overlay, motions limited to one of the four quadrants of the overlay, circular motions, and application dependent functionality. Such additional or alternative functionality may be implemented using methods and systems similar to those described herein.

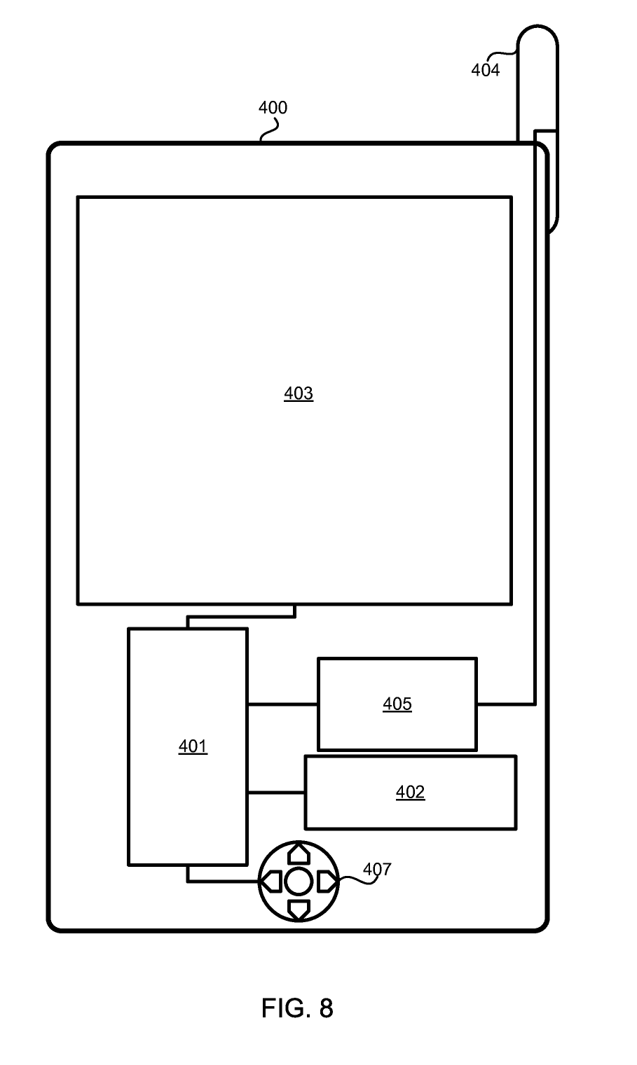

Typical mobile devices 1 suitable for use with the various embodiments will have in common the components illustrated in FIG. 8. For example, a mobile receiver device 400 may include a processor 401 coupled to internal memory 402, and a touchscreen display 403. Additionally, the mobile device 400 may have an antenna 404 for sending and receiving electromagnetic radiation that is connected to a wireless data link and/or cellular telephone transceiver 405 coupled to the processor 401. Mobile devices typically also include menu selection buttons or rocker switches 407 for receiving user inputs. While FIG. 8 illustrates a mobile computing device, other forms of computing devices, including personal computers and laptop computers, will typically also include a processor 401 coupled to internal memory 402, and a touchscreen display 403. Thus, FIG. 8 is not intended to limit the scope of the claims to a mobile computing device in the particular illustrated form factor.

The processor 401 may be any programmable microprocessor, microcomputer or multiple processor chip or chips that can be configured by software instructions (applications) to perform a variety of functions, including the functions of the various embodiments described herein. In some mobile devices, multiple processors 401 may be provided, such as one processor dedicated to wireless communication functions and one processor dedicated to running other applications. Typically, software applications may be stored in the internal memory 402 before they are accessed and loaded into the processor 401. In some mobile devices, the processor 401 may include internal memory sufficient to store the application software instructions. In some mobile devices, the secure memory may be in a separate memory chip coupled to the processor 401. In many mobile devices 400 the internal memory 402 may be a volatile or nonvolatile memory, such as flash memory, or a mixture of both. For the purposes of this description, a general reference to memory refers to all memory accessible by the processor 401, including internal memory 402, removable memory plugged into the mobile device, and memory within the processor 401 itself.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored on or transmitted over as one or more instructions or code on a computer-readable medium. The steps of a method or algorithm disclosed herein may be embodied in a processor-executable software module executed which may reside on a tangible non-transitory computer-readable medium. Tangible non-transitory computer-readable media may be any available non-transitory media that may be accessed by a computer. By way of example, and not limitation, such non-transitory computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of non-transitory computer-readable media. Additionally, the operations of a method or algorithm may reside as one or any combination or set of codes and/or instructions on a non-transitory machine readable medium and/or non-transitory computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method of implementing a user interface function on a computing device equipped with a touchscreen display, comprising:
displaying a translucent gesture recognition overlay area on a portion of the touchscreen display;
detecting a first touch event on the touchscreen within the gesture recognition overlay;
determining an intended cursor movement within a displayed text string based on the detected first touch event;
determining a character adjacent to a current position of a cursor within the displayed text string after the determined intended cursor movement;
displaying, on the touchscreen, an enlarged portion of the character; and
updating the cursor position in the displayed text string.

2. The method of claim 1, wherein displaying a translucent gesture recognition overlay area on a portion of the touchscreen display is accomplished in response to detecting a user input corresponding to activation of a gesture recognition overlay functionality.

3. The method of claim 2, wherein the user input corresponding to activation of a gesture recognition overlay functionality comprises a press of a physical button on the computing device.

4. The method of claim 1, wherein determining an intended cursor movement within a displayed text string based on the detected touch event comprises:
determining from the first touch event whether a user has touched the gesture recognition overlay with a finger or stylus near an edge; and
determining from motion of the first touch event whether the user has dragged the finger or stylus towards the opposite edge of the gesture recognition overlay along a centerline.

5. The method of claim 4, wherein displaying, on the touchscreen, an enlarged portion of the character comprises:
displaying an enlarged portion of the character within the gesture recognition overlay; and
periodically updating the display of the enlarged portion based on movement of the first touch event across the gesture recognition overlay.

6. The method of claim 1, further comprising:
recognizing a character sketched in the gesture recognition overlay; and
adding the recognized character to the displayed text string at the updated cursor position.

7. The method of claim 1, further comprising:
detecting a user input corresponding to activation of a text selection mode; and
highlighting the character when the text selection mode is activated.

8. The method of claim 1, further comprising:
detecting a user input corresponding to activation of a text selection mode; and
highlighting a word in a direction of movement of the first touch event when the text selection mode is activated.

9. The method of claim 1, further comprising determining a speed of movement of the first user input,
wherein determining an intended cursor movement within a displayed text string based on the detected first touch event comprises determining that a single character movement of the cursor is intended when the speed of movement of the first user input is slow, and determining that a multi-character movement of the cursor is intended when the speed of the movement of the first user input is fast.

10. The method of claim 1, further comprising:
displaying a menu of functions comprising one or more menu icons within the gesture recognition overlay in response to detecting a user input corresponding to activation of a toolbar functionality;
detecting a user touch on one or more menu icons; and
implementing a function corresponding to the touch one or more menu icons.

11. A computing device, comprising:
a processor; and
a touchscreen display coupled to the processor,
wherein the processor is configured with processor-executable instructions to perform operations comprising:
displaying a translucent gesture recognition overlay area on a portion of the touchscreen display;
detecting a first touch event on the touchscreen within the gesture recognition overlay;
determining an intended cursor movement within a displayed text string based on the detected first touch event;
determining a character adjacent to a current position of a cursor within the displayed text string after the determined intended cursor movement;
displaying, on the touchscreen, an enlarged portion of the character; and
updating the cursor position in the displayed text string.

12. The computing device of claim 11, wherein the processor is configured with processor-executable instructions to perform operations such that displaying a translucent gesture recognition overlay area on a portion of the touchscreen display is accomplished in response to detecting a user input corresponding to activation of a gesture recognition overlay functionality.

13. The computing device of claim 12, wherein the processor is configured with processor-executable instructions to perform operations such that the user input corresponding to activation of a gesture recognition overlay functionality comprises a press of a physical button on the computing device.

14. The computing device of claim 11, wherein the processor is configured with processor-executable instructions to perform operations such that determining an intended cursor movement within a displayed text string based on the detected touch event comprises:
determining from the first touch event whether a user has touched the gesture recognition overlay with a finger or stylus near an edge; and
determining from motion of the first touch event whether the user has dragged the finger or stylus towards the opposite edge of the gesture recognition overlay along a centerline.

15. The computing device of claim 14, wherein the processor is configured with processor-executable instructions to perform operations such that displaying, on the touchscreen, an enlarged portion of the character comprises:
displaying an enlarged portion of the character within the gesture recognition overlay; and
periodically updating the display of the enlarged portion based on movement of the first touch event across the gesture recognition overlay.

16. The computing device of claim 11, wherein the processor is configured with processor-executable instructions to perform operations further comprising:
recognizing a character sketched in the gesture recognition overlay; and
adding the recognized character to the displayed text string at the updated cursor position.

17. The computing device of claim 11, wherein the processor is configured with processor-executable instructions to perform operations further comprising:
detecting a user input corresponding to activation of a text selection mode; and
highlighting the character when the text selection mode is activated.

18. The computing device of claim 11, wherein the processor is configured with processor-executable instructions to perform operations further comprising:
detecting a user input corresponding to activation of a text selection mode; and
highlighting a word in a direction of movement of the first touch event when the text selection mode is activated.

19. The computing device of claim 11, wherein the processor is configured with processor-executable instructions to perform operations further comprising determining a speed of movement of the first user input,
wherein the processor is configured with processor-executable instructions to perform operations such that determining an intended cursor movement within a displayed text string based on the detected first touch event comprises determining that a single character movement of the cursor is intended when the speed of movement of the first user input is slow, and determining that a multi-character movement of the cursor is intended when the speed of the movement of the first user input is fast.

20. The computing device of claim 11, wherein the processor is configured with processor-executable instructions to perform operations further comprising:
displaying a menu of functions comprising one or more menu icons within the gesture recognition overlay in response to detecting a user input corresponding to activation of a toolbar functionality;
detecting a user touch on one or more menu icons; and
implementing a function corresponding to the touch one or more menu icons.

21. A computing device, comprising:
a touchscreen display;
means for displaying a translucent gesture recognition overlay area on a portion of the touchscreen display;
means for detecting a first touch event on the touchscreen within the gesture recognition overlay;
means for determining an intended cursor movement within a displayed text string based on the detected first touch event;
means for determining a character adjacent to a current position of a cursor within the displayed text string after the determined intended cursor movement;
means for displaying, on the touchscreen, an enlarged portion of the character; and
means for updating the cursor position in the displayed text string.

22. The computing device of claim 21, wherein means for displaying a translucent gesture recognition overlay area on a portion of the touchscreen display comprises means for displaying a translucent gesture recognition overlay area on a portion of the touchscreen display in response to detecting a user input corresponding to activation of a gesture recognition overlay functionality.

23. The method of claim 22, wherein the user input corresponding to activation of a gesture recognition overlay functionality comprises a press of a physical button on the computing device.

24. The computing device of claim 21, wherein means for determining an intended cursor movement within a displayed text string based on the detected touch event comprises:
means for determining from the first touch event whether a user has touched the gesture recognition overlay with a finger or stylus near an edge; and
means for determining from motion of the first touch event whether the user has dragged the finger or stylus towards the opposite edge of the gesture recognition overlay along a centerline.

25. The computing device of claim 24, wherein means for displaying, on the touchscreen, an enlarged portion of the character comprises:
means for displaying an enlarged portion of the character within the gesture recognition overlay; and
means for periodically updating the display of the enlarged portion based on movement of the first touch event across the gesture recognition overlay.

26. The computing device of claim 21, further comprising:
means for recognizing a character sketched in the gesture recognition overlay; and
means for adding the recognized character to the displayed text string at the updated cursor position.

27. The computing device of claim 21, further comprising:
means for detecting a user input corresponding to activation of a text selection mode; and
means for highlighting the character when the text selection mode is activated.

28. The computing device of claim 21, further comprising:
means for detecting a user input corresponding to activation of a text selection mode; and
means for highlighting a word in a direction of movement of the first touch event when the text selection mode is activated.

29. The computing device of claim 21, further comprising means for determining a speed of movement of the first user input,
wherein means for determining an intended cursor movement within a displayed text string based on the detected first touch event comprises means for determining that a single character movement of the cursor is intended when the speed of movement of the first user input is slow, and determining that a multi-character movement of the cursor is intended when the speed of the movement of the first user input is fast.

30. The computing device of claim 21, further comprising:
means for displaying a menu of functions comprising one or more menu icons within the gesture recognition overlay in response to detecting a user input corresponding to activation of a toolbar functionality;
means for detecting a user touch on one or more menu icons; and
means for implementing a function corresponding to the touch one or more menu icons.

31. A non-transitory computer-readable storage medium having stored thereon processor-executable instructions configured to cause a processor of a computing device equipped with a touchscreen display to perform operations comprising:
displaying a translucent gesture recognition overlay area on a portion of the touchscreen display;
detecting a first touch event on the touchscreen within the gesture recognition overlay;
determining an intended cursor movement within a displayed text string based on the detected first touch event;
determining a character adjacent to a current position of a cursor within the displayed text string after the determined intended cursor movement;
displaying, on the touchscreen, an enlarged portion of the character; and
updating the cursor position in the displayed text string.

32. The non-transitory computer-readable storage medium of claim 31, wherein the stored processor-executable instructions are configured to cause a computing device processor to perform operations such that displaying a translucent gesture recognition overlay area on a portion of the touchscreen display is accomplished in response to detecting a user input corresponding to activation of a gesture recognition overlay functionality.

33. The method of claim 32, wherein the user input corresponding to activation of a gesture recognition overlay functionality comprises a press of a physical button on the computing device.

34. The non-transitory computer-readable storage medium of claim 31, wherein the stored processor-executable instructions are configured to cause a computing device processor to perform operations such that determining an intended cursor movement within a displayed text string based on the detected touch event comprises:
determining from the first touch event whether a user has touched the gesture recognition overlay with a finger or stylus near an edge; and
determining from motion of the first touch event whether the user has dragged the finger or stylus towards the opposite edge of the gesture recognition overlay along a centerline.

35. The non-transitory computer-readable storage medium of claim 34, wherein the stored processor-executable instructions are configured to cause a computing device processor to perform operations such that displaying, on the touchscreen, an enlarged portion of the character comprises:
displaying an enlarged portion of the character within the gesture recognition overlay; and
periodically updating the display of the enlarged portion based on movement of the first touch event across the gesture recognition overlay.

36. The non-transitory computer-readable storage medium of claim 31, wherein the stored processor-executable instructions are configured to cause a computing device processor to perform operations further comprising:
recognizing a character sketched in the gesture recognition overlay; and
adding the recognized character to the displayed text string at the updated cursor position.

37. The non-transitory computer-readable storage medium of claim 31, wherein the stored processor-executable instructions are configured to cause a computing device processor to perform operations further comprising:
detecting a user input corresponding to activation of a text selection mode; and
highlighting the character when the text selection mode is activated.

38. The non-transitory computer-readable storage medium of claim 31, wherein the stored processor-executable instructions are configured to cause a computing device processor to perform operations further comprising:
detecting a user input corresponding to activation of a text selection mode; and
highlighting a word in a direction of movement of the first touch event when the text selection mode is activated.

39. The non-transitory computer-readable storage medium of claim 31, wherein the stored processor-executable instructions are configured to cause a computing device processor to perform operations further comprising determining a speed of movement of the first user input,
wherein the stored processor-executable instructions are configured to cause a processor to perform operations such that determining an intended cursor movement within a displayed text string based on the detected first touch event comprises determining that a single character movement of the cursor is intended when the speed of movement of the first user input is slow, and determining that a multi-character movement of the cursor is intended when the speed of the movement of the first user input is fast.

40. The non-transitory computer-readable storage medium of claim 31, wherein the stored processor-executable instructions are configured to cause a computing device processor to perform operations further comprising:
displaying a menu of functions comprising one or more menu icons within the gesture recognition overlay in response to detecting a user input corresponding to activation of a toolbar functionality;
detecting a user touch on one or more menu icons; and
implementing a function corresponding to the touch one or more menu icons.
